(19) United States
(12) Patent Application Publication
(10) Pub. No.: US 2007/0056253 A1
(43) Pub. Date: Mar. 15, 2007

(54) Vacuum cleaner cartridge filter turbine

(76) Inventor: Juris Terauds, Olivenhain, CA (US)

Correspondence Address: JURIS TERAUDS, 3319 LONE JACK ROAD, OLIVENHAIN, CA, 92024, US

(21) Appl. No.: 11/226,262

(22) Filed: Sep. 15, 2005

(51) Int. Cl. B01D 46/00

(52) U.S. Cl. 55/282

(57) ABSTRACT

The present invention relates to a vacuum cleaner cartridge filter turbine, consisting of a turbine vacuum power unit mount, a turbine impeller blade and a cartridge filter cage mount. The suction air stream through the shop vacuum cleaner and through the turbine impeller blade rotates the cartridge filter on the filter mount of the cartridge filter turbine, creating centrifugal force on the outer surface of the rotating cartridge filter, which inhibits particles carried by the air from settling on the filter. This rotating action of the filter keeps the filter relatively clean, allowing air to pass through the filter unobstructed and thus prolonging the optimum function of the filter and reducing otherwise required filter service. The shop vacuum cleaner cartridge filter turbine can readily be built into a new vacuum cleaner or retrofitted in existing vacuum cleaners.

### BACKGROUND OF THE INVENTION

The present invention relates to vacuum cleaners, in particular to vacuum cleaners using cartridge filters, such as the canister shop vacuum cleaners used for sucking dirt, debris and material particles from floors and work areas.

Shop vacuum cleaners with round cartridge filters are ubiquitous in private homes, shops and institutions. When they are operated with a clean filter, the airflow through the filter is not obstructed by foreign particles, the power and volume of the suction of the vacuum cleaner at the intake nozzle is adequate. However, quickly, with continuous use the outer surface of the filter accumulates particles, such that the airflow is blocked and decreased with the vacuum cleaner loosing suction power and airflow volume at the intake. Each time the filter gets obstructed by particles of debris suction power decreases and the filter has to be cleaned or replaced. Consequently, operation of the vacuum cleaner has to be interrupted frequently with time lost and energy expended while replacing or cleaning the filter. Further, this untimely replacement of the filter adds to the cost of operating the vacuum cleaner. Prior art does not address the above-described round cartridge vacuum filter clogging problems adequately.

To avoid the frequent interruption of the round cartridge vacuum cleaner operation and to reduce the cost of operating the vacuum cleaner, the particles being carried by the air into the vacuum cleaner must be kept from landing and building up on the filter surface. This can be accomplished by rotating the filter during operation, such that the centrifugal force created at the surface of the filter, by its rotation, prevents particles from landing on the rotating surface of the filter.

Accordingly, it has been deemed desirable to develop a system for rotating the cartridge filter, such that the cartridge filter rotates while the vacuum cleaner is operating. Preferable is a vacuum cleaner cartridge filter turbine that can be built in new vacuum cleaners or retrofitted in the thousands of vacuum cleaners now in use, at a low cost, and with advantageous overall results. The present art addresses exactly this problem with the vacuum cleaner cartridge filter turbine invention.

### BRIEF SUMMARY OF THE INVENTION

According to the present invention, a novel shop vacuum cleaner cartridge filter turbine is provided.

In accordance with the invention, a vacuum cleaner cartridge filter turbine, which includes a turbine vacuum power unit mount, a turbine impeller and a turbine filter cage mount, assembled with bearing wheels, rotationally holding the above mentioned three parts together, while being attached to the turbine filter cage mount, traveling along the turbine bearing track of the turbine vacuum power unit mount, and along the turbine bearing track of the turbine.

The turbine filter cage mount is rotationally driven by the turning of the turbine bearings, which are rotated by the turbine impeller, with energy derived from the air flowing through the turbine impeller. The rotation of the turbine filter cage mount, with the cartridge filter mounted thereon, creates centrifugal force at the surface of the filter, inhibiting particles, carried by the passing air, from landing on the surface of the filter.

It is therefore an object of the present invention to provide a vacuum cleaner cartridge filter turbine, which when operated in a vacuum cleaner, keeps the filter surface relatively free of particles. Further, it is an object of the present invention to provide an inexpensive vacuum cleaner cartridge filter turbine for new vacuum cleaners. Still further, it is an object of the present invention to provide an inexpensive vacuum cleaner cartridge filter turbine for retrofitting old vacuum cleaners. And still further, to provide a vacuum cleaner cartridge filter turbine, which can be installed with minimum effort and at a low cost. These and other objects will become increasingly apparent to those skilled in the art by reference to the drawings and further explanations.

### DESCRIPTION OF DRAWINGS OF THE INVENTION

The accompanying drawings are incorporated in and constitute a part of this description of the invention, they serve to example the principles of this invention.

FIG. 1 is a side cross-sectional view along the vertical axis of the vacuum cleaner cartridge filter turbine in accordance with the present invention.

FIG. 2 is a top plan view of the cartridge filter turbine impeller.

FIG. 3 is a top plan view of the cartridge filter turbine impeller riding on the bearings mounted on the turbine filter cage mount.

### DETAILED DESCRIPTION OF THE INVENTION

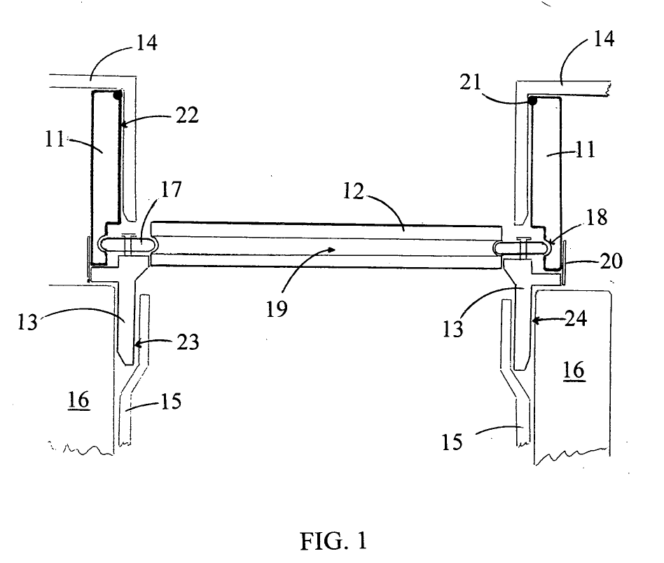

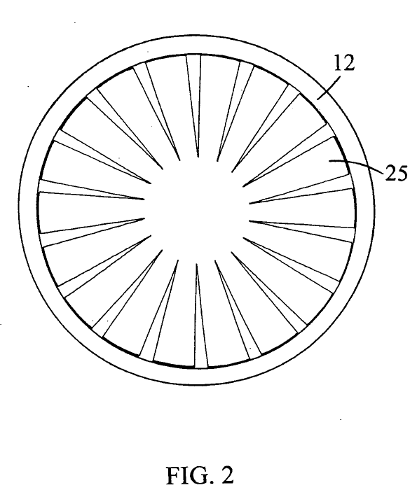

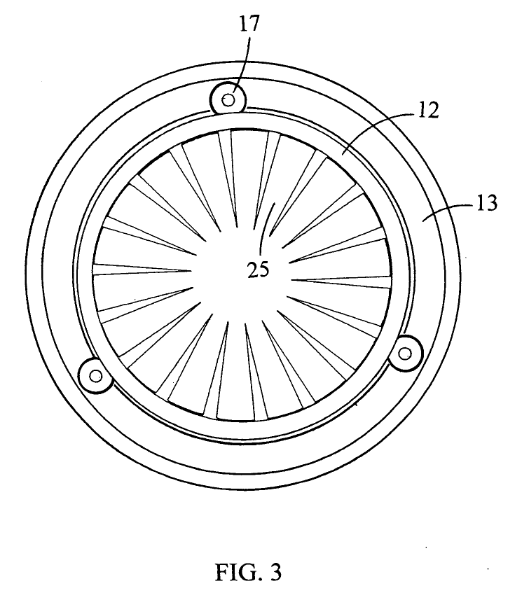

Referring now to the FIGURES, the showings are for purposes of illustrating preferred embodiments of the invention only and not for limiting the same. FIG. 1 illustrates a side cross-section along the vertical axis of the assembled parts of the vacuum cleaner cartridge filter turbine, while FIGS. 2 and 3 illustrate the top plan view of the cartridge filter turbine impeller and the top plan view of the cartridge filter turbine impeller riding on the bearings of the turbine filter cage mount, respectively.

Power to rotate the cartridge filter is provided by the vacuum cleaner power unit via air sucked through the power unit, creating an air stream through the turbine impeller 12, illustrated in FIGS. 1, 2 and 3, which rotates the turbine impeller 12, which is riding on the turbine bearing 17, mounted on the turbine filter cage mount 13. The spinning turbine bearing 17 travels in the turbine bearing track of the turbine vacuum power mount, carrying with it the turbine filter cage mount 13 together with the cartridge filter cage 15 and cartridge filter 16.

Continuing with FIG. 1, the angular velocity of the turbine filter cage mount 13, together with the cartridge filter cage 15 and cartridge filter 16 is directly proportional to the diameter of the turbine bearing track on the turbine vacuum power mount, the diameter of the turbine bearing wheels 17 and the diameter of the turbine bearing track on the turbine impeller. In general terms, the greater the diameter of the turbine bearing 17, while the diameter of turbine impeller 12 is decreased, the lower the angular velocity of turbine filter cage mount 13.

By examining FIG. 1, it becomes clear that using the turbine bearings 17 in this unique way, attached to the turbine filter cage mount 13, the turbine filter cage mount 13 is free to rotate in either direction in the turbine bearing track of the turbine vacuum power unit mount 11. At the same time, it should be noted that the turbine impeller 12, (FIGS. 1, 2, AND 3) is not attached to either, the turbine vacuum power unit mount 11, or the turbine filter cage mount 13, but travels freely on the turbine bearings 17 on the turbine bearing track 19 of the turbine impeller 12.

Drawing attention to FIG. 2 and FIG. 3, we can see the turbine impeller 12 and understand that the angle of attack of the blades 25 of the impeller 12, in relationship to the direction of the air flow, will alter the influence of the air stream on the turbine impeller 12. Generally, as the angle of attack of the blades 25 are decreased, the angular velocity of the turbine impeller 12 is decrease. Conversely, as the angle of attack of the blades 25 of the turbine impeller 12 are increased, the angular velocity of the turbine impeller blade 12 is increased.

From the foregoing discussion it can be seen that the angular velocity at which the turbine filter cage mount 13 turns can be altered by a combination of changes of the diameters of the turbine vacuum power unit mount 11, the diameter of the turbine bearings 17 and the diameter of the turbine impeller 12, as well as the angle of attack of the blades 25 of the turbine impeller 12.

Again, referring to FIG. 1, to prevent unfiltered air, with dust particles, from entering the airs-stream after the filter, an o-ring dust seal 21 is inserted between the turbine vacuum power unit mount 11 and the vacuum power unit 14. Also, a flap seal 20 is mounted on the turbine vacuum power unit mount 11, such that it overlaps the space between the turbine vacuum power unit mount 11 and turbine filter cage mount 13.

To retrofit vacuum cleaners with the vacuum cleaner cartridge filter turbine, (FIG. 1), the vacuum cleaner cartridge filter turbine, is installed on the lip of the vacuum power unit 14, designed for holding the filter cage and the filter. Then, the regular cartridge filter cage 15 is installed in the turbine filter cage mount 13, on the turbine filter cage mount filter cage interface, and the cartridge filter 16 is installed on the cartridge filter cage 15 and the turbine filter cage mount and cartridge filter interface 24.

Further, it should be noted, that the vacuum cleaner cartridge filter turbine is not limited to retrofitting existing vacuum cleaners, but can very economically be made a part of newly built vacuum cleaners.

Still further, the present invention is not limited to the turbine bearing s17 (FIG. 1) being attached to the turbine filter cage mount 13, but with a slight change of design, the turbine bearings 17 could just as well be attached to turbine vacuum power unit mount 11, producing similar results to those just described.

The preferred materials to be used for the manufacture of the vacuum cleaner cartridge filter turbine can be any materials that produce satisfactory results at a low cost, such as molded plastics, but not limited to plastics. To emphasize this point, referring to FIG. 1, the turbine vacuum power unit mount 11, the turbine impeller 12, the turbine filter cage mount 13, the turbine bearing 17, the o-ring dust seal 21, the flap seal 20 and any other parts can be made of one or several materials to produce the optimum result in performance and cost.

The invention has been described with detailed reference to the preferred embodiments. Obviously there will occur, possible modifications and alterations, to others reading and understanding the preceding detailed description. It is intended that the invention be construed as including all such possible modifications and alterations insofar as they come within the scope of the claims or the equivalents thereof.

What is claimed is:

1. A vacuum cleaner cartridge filter turbine, for rotating cartridge vacuum cleaner filters.

2. A vacuum cleaner cartridge filter turbine as claimed in 1, wherein the vacuum cleaner cartridge filter turbine may be attached to the existing filter and cage attachment mount of the vacuum cleaner as a retrofit.

3. A vacuum cleaner cartridge filter turbine as claimed in 1, wherein the vacuum cleaner cartridge filter turbine may be built as a part of a newly manufactured vacuum cleaner.

4. A vacuum cleaner cartridge filter turbine as claimed in 1, wherein the cartridge filter mount of the turbine accommodates the original vacuum cleaner filter cage mount and filter.

5. A vacuum cleaner cartridge filter turbine as claimed in 1, wherein the cartridge filter mount of the turbine accommodates specially designed filter cage mounts and filters.

6. A vacuum cleaner cartridge filter turbine driven by the air stream passing through the vacuum cleaner.

7. A vacuum cleaner cartridge filter turbine consisting of a filter cage mount with three or more bearing wheels attached, such that the bearing wheels travel on the inside bearing track of a vacuum power unit mount and such that these bearing wheels travel along the outside track of an impeller, thus holding the impeller in place between them.

8. A vacuum cleaner cartridge filter turbine as claimed in 7, wherein the bearing wheels are attached to the vacuum cleaner unit mount, such that they ride on the inside bearing track of the filter cage mount and such that the bearing wheels ride along the outside track of the impeller, thus holding the impeller in place between them.

9. A vacuum cleaner cartridge filter turbine as claimed in 7, wherein the diameter of the rotationally interacting parts may be changed to alter the angular velocity of the cartridge filter.

10. A vacuum cleaner cartridge filter turbine as claimed in 7, wherein the angle of the blades of the impeller may be adjusted, to alter the angular velocity of the cartridgefilter.
